(19) United States
(12) Patent Application Publication
(10) Pub. No.: US 2026/0001792 A1
(43) Pub. Date: Jan. 1, 2026

(54) METHOD FOR PRODUCING SLIME-SUPPRESSING AUXILIARY AGENT FOR REVERSE OSMOSIS MEMBRANE, SLIME-SUPPRESSING AUXILIARY AGENT FOR REVERSE OSMOSIS MEMBRANE, AND WATER TREATMENT METHOD

(71) Applicant: ORGANO CORPORATION, Tokyo (JP)

(72) Inventors: Mitsuya MORI, Tokyo (JP); Shohei YAMAMOTO, Tokyo (JP)

(73) Assignee: ORGANO CORPORATION, Tokyo (JP)

(21) Appl. No.: 19/105,452

(22) PCT Filed: Jul. 28, 2023
(86) PCT No.: PCT/JP2023/027696

§ 371 Date: Feb. 21, 2025

(30) Foreign Application Priority Data
Aug. 31, 2022 (JP) 2022-137803

(51) Int. Cl. C02F 1/68; C02F 1/44

(52) U.S. Cl. CPC C02F 1/68; C02F 1/441; C02F 2303/20

(57) ABSTRACT

Provided is a method for producing a slime-suppressing auxiliary agent which is for a reverse osmosis membrane and which contains an iodide and suppresses the release of iodine. This method for producing a slime-suppressing auxiliary agent for a reverse osmosis membrane includes adding an iodide and an alkali agent to water having a free chlorine concentration of 0.2 mg/L or less.

### TECHNICAL FIELD

The present invention relates to a method for producing a slime-suppressing auxiliary agent for a reverse osmosis membrane, a slime-suppressing auxiliary agent for a reverse osmosis membrane, and a water treatment method that uses the slime-suppressing auxiliary agent for a reverse osmosis membrane.

### BACKGROUND

Reverse osmosis membrane treatments using a reverse osmosis membrane are used in many processes such as pure water production, wastewater recovery and seawater desalination, and against the backdrop of water shortages of recent years, examples of the application of reverse osmosis membrane treatments to wastewater recovery applications have increased significantly. Reverse osmosis membrane treatments are generally applied following a pretreatment step such as a sand filtration or membrane filtration treatment, and a chlorine-based oxidizing agent such as hypochlorous acid is usually used to suppress slime formation caused by microbe proliferation in the pretreatment step, but if the chlorine-based oxidizing agent such as hypochlorous acid flows through to the reverse osmosis membrane, marked degradation of the membrane performance occurs, and therefore a reducing agent is added to the water supplied to the reverse osmosis membrane to decompose the hypochlorous acid or the like and suppress degradation of the reverse osmosis membrane.

However, if a water that has a reduced suppression effect on slime formation due to the addition of a reducing agent is supplied to a reverse osmosis membrane, then microbes can proliferate on the membrane surface causing biofouling, which can sometimes cause trouble such as a reduction in the permeate volume or an increase in the supply pressure.

As a result, an antibacterial agent (slime-suppressing agent) that makes membrane degradation of the reverse osmosis membrane less likely, such as a stabilized chlorine compound such as chloramine or chlorosulfamic acid, or a stabilized hypobromous acid composition containing a bromine-based oxidizing agent such as bromine and sulfamic acid, is added to the reverse osmosis membrane supply water containing the added reducing agent to inhibit biofouling.

However, a problem arises in that if the amount added of the reducing agent is excessive, then the antibacterial agent may be reduced and consumed by the reducing agent, resulting in increases in the amounts of agent that must be added and the associated chemical costs, whereas if the amount added of the reducing agent is too low, residual hypochlorous acid or the like tends to cause membrane degradation.

For example, Patent Document 1 discloses that in a reverse osmosis membrane treatment, by adding sodium metabisulfite as a reducing agent to a water to be treated containing added sodium hypochlorite prior to a reverse osmosis membrane treatment, and also adding potassium iodide to generate iodine, microbe contamination can be suppressed.

However, no clear description is provided regarding the amount of potassium iodide necessary for the hypochlorous acid or the like, and if the amount added of the potassium iodide is too low, then there is a possibility that hypochlorous acid that has not been reduced may cause degradation of the reverse osmosis membrane, whereas if the amount added of the potassium iodide is excessive, then the chemical costs may increase.

On the other hand, it is known that iodide aqueous solutions, upon exposure to the air, oxidize and release free iodine. Because iodine has sublimability and corrosive properties, the material for the storage container for the iodide aqueous solution needs to be an expensive material. Further, because iodine has oxidizing power, when an iodide aqueous solution is used for reducing residual chlorine in a water to be treated, the expected reducing power can sometimes not be achieved. For these types of reasons, it is necessary to suppress the release of free iodine in the iodide aqueous solution.

In Patent Document 2, the examples disclose that a 1 N sodium hydroxide aqueous solution containing 5% by weight of potassium iodide remains colorless after one week at room temperature.

Further, Patent Document 3 discloses that by adding an alkali compound to adjust the pH of a solution containing at least one substance selected from the group consisting of simple iodine, compounds containing the iodine element, iodide ions, and ions containing the iodine element in a concentration of less than 10% by mass, the release of iodine into the air upon evaporation and concentration can be suppressed.

However, in all of the iodide aqueous solutions disclosed in Patent Documents 2 and 3, the suppression of free iodine is inadequate. Accordingly, a water treatment agent composition composed of an iodide aqueous solution for which the release of free iodine is suppressed would be very desirable for use in slime suppression on reverse osmosis membranes.

### CITATION LIST

### Patent Literature

Patent Document 1: JP S56-033009 A
Patent Document 2: JP 2010-271141 A
Patent Document 3: JP 2006-232662 A

### SUMMARY

### Technical Problem

Objects of the present invention are to provide a method for producing a slime-suppressing auxiliary agent for a reverse osmosis membrane that contains an iodide but exhibits suppression of the release of free iodine, and to provide a slime-suppressing auxiliary agent for a reverse osmosis membrane.

Further, another object of the present invention is to provide a water treatment method which, in the reverse osmosis membrane treatment of a water to be treated containing at least one of a chlorine-based oxidizing agent and a bromine-based oxidizing agent, is able to suppress degradation of the reverse osmosis membrane and also suppress slime formation.

### Solution to Problem

The present invention provides a method for producing a slime-suppressing auxiliary agent for a reverse osmosis membrane, the method including an addition step of adding an iodide and an alkali agent to a water having a free chlorine concentration of 0.2 mg/L or less.

The present invention also provides a method for producing a slime-suppressing auxiliary agent for a reverse osmosis membrane, the method including a removal step of removing free chlorine from a water having a free chlorine concentration exceeding 0.2 mg/L to reduce the free chlorine concentration to 0.2 mg/L or less, and an addition step of adding an iodide and an alkali agent to the water from which free chlorine has been removed.

The present invention also provides a slime-suppressing auxiliary agent for a reverse osmosis membrane, the slime-suppressing auxiliary agent containing an iodide, an alkali agent and water, and having a free iodine concentration of 0.1 mg/L or less.

In the above slime-suppressing auxiliary agent for a reverse osmosis membrane, the iodide ion concentration is preferably at least 3.8% by mass but less than 20% by mass.

In the above slime-suppressing auxiliary agent for a reverse osmosis membrane, the pH is preferably 8 or higher.

The present invention also provides a water treatment method including a reverse osmosis membrane treatment step of treating a water to be treated containing at least one of a chlorine-based oxidizing agent and a bromine-based oxidizing agent using a reverse osmosis membrane to obtain a concentrate and a permeate, wherein the slime-suppressing auxiliary agent for a reverse osmosis membrane described above is introduced into the water to be treated such that the amount of iodide ions is at least 2 mol per 1 mol of free chlorine and free bromine in the water to be treated.

The present invention also provides a water treatment method including a membrane filtration treatment step of subjecting a water to be treated containing at least one of a chlorine-based oxidizing agent and a bromine-based oxidizing agent to a membrane filtration treatment using a separation membrane, and a reverse osmosis membrane treatment step of treating the membrane filtration treated water obtained in the membrane filtration treatment step using a reverse osmosis membrane to obtain a concentrate and a permeate, wherein the slime-suppressing auxiliary agent for a reverse osmosis membrane described above is introduced into the water to be treated in the membrane filtration treatment step such that the amount of iodide ions is at least 2 mol per 1 mol of free chlorine and free bromine in the water to be treated.

### Advantageous Effects of Invention

The present invention is able to provide method for producing a slime-suppressing auxiliary agent for a reverse osmosis membrane that contains an iodide but exhibits suppression of the release of free iodine, and also provide a slime-suppressing auxiliary agent for a reverse osmosis membrane.

Further, the present invention is also able to provide a water treatment method which, in the reverse osmosis membrane treatment of a water to be treated containing at least one of a chlorine-based oxidizing agent and a bromine-based oxidizing agent, is able to suppress degradation of the reverse osmosis membrane and also suppress slime formation.

### BRIEF DESCRIPTION OF DRAWINGS

FIG. 1 is a schematic structural diagram illustrating one example of a water treatment device for implementing a water treatment method using the slime-suppressing auxiliary agent for a reverse osmosis membrane according to an embodiment of the present invention.

FIG. 2 is a schematic structural diagram illustrating another example of a water treatment device for implementing a water treatment method using the slime-suppressing auxiliary agent for a reverse osmosis membrane according to an embodiment of the present invention.

FIG. 3 is a graph illustrating the reactivity in Example 4.

FIG. 4 is a graph illustrating the oxidation-reduction potential (ORP) of products in Example 4 and Reference Examples 3 and 4.

### DESCRIPTION OF EMBODIMENTS

Embodiments of the present invention are described below. These embodiments are merely examples of implementing the present invention, and the present invention is not limited to these embodiments.

### Water Treatment Device and Water Treatment Method

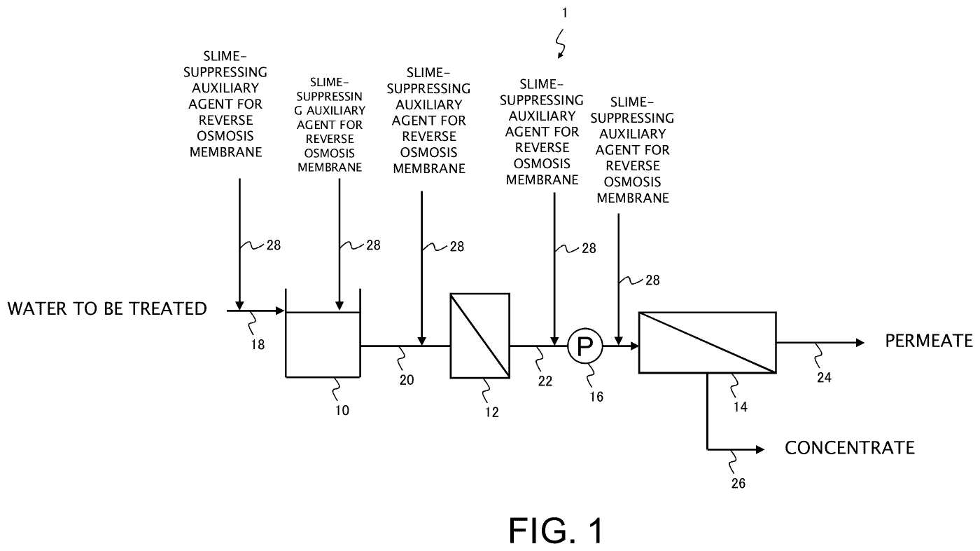

An outline of one example of a water treatment device for implementing a water treatment method using the slime-suppressing auxiliary agent for a reverse osmosis membrane according to an embodiment of the present invention is illustrated in FIG. 1.

The water treatment device 1 is provided with a reverse osmosis membrane device 14 which functions as a reverse osmosis membrane treatment unit for treating a water to be treated containing at least one of a chlorine-based oxidizing agent and a bromine-based oxidizing agent using a reverse osmosis membrane to obtain a concentrate and a permeate. The water treatment device 1 may also have a water to be treated tank 10 for storing the water to be treated. The water treatment device 1 may also be provided with, at a stage prior to the reverse osmosis membrane device 14, a membrane filtration device 12 which functions as a membrane filtration treatment unit for subjecting the water to be treated containing at least one of a chlorine-based oxidizing agent and a bromine-based oxidizing agent to a membrane filtration treatment using a separation membrane.

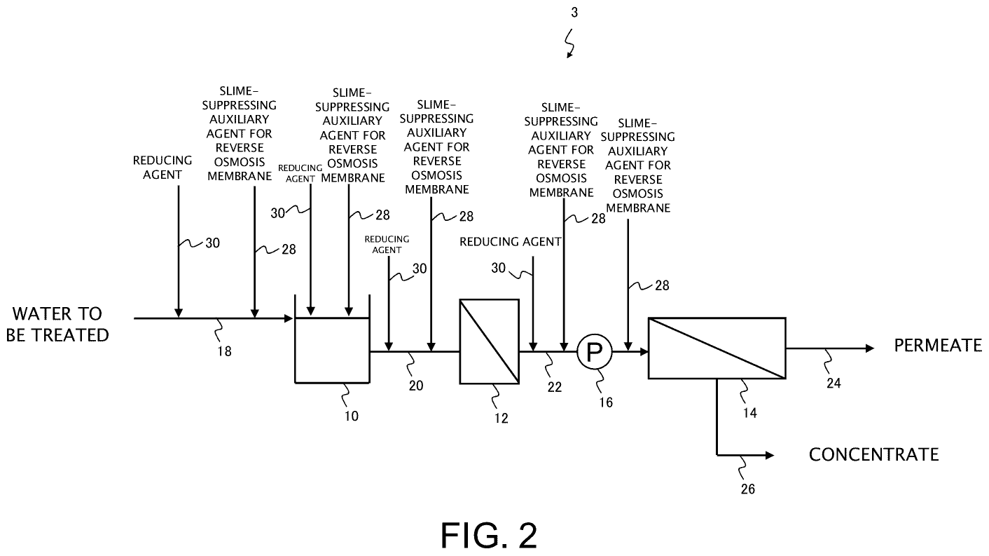

In the water treatment device 1 of FIG. 1, a water to be treated line 18 is connected to a water to be treated inlet of the water to be treated tank 10. A water to be treated outlet of the water to be treated tank 10 and a water to be treated inlet of the membrane filtration device 12 are connected by a water to be treated line 20. A membrane filtration treated water outlet of the membrane filtration device 12 and a membrane filtration treated water inlet of the reverse osmosis membrane device 14 are connected by a membrane filtration treated water line 22 via a pump 16. A permeate line 24 is connected to a permeate outlet of the reverse osmosis membrane device 14, and a concentrate line 26 is connected to a concentrate outlet. A slime-suppressing auxiliary agent addition line 28 may be connected to at least one of the water to be treated line 18, the water to be treated tank 10, the water to be treated line 20, the membrane filtration treated water line 22 at a location upstream from the pump 16, or the membrane filtration treated water line 22 at a location after the pump 16 as a slime-suppressing auxiliary agent addition unit for adding the slime-suppressing auxiliary agent for a reverse osmosis membrane. As illustrated in FIG. 2, a reducing agent addition line 30 may be connected to at least one of the water to be treated line 18, the water to be treated tank 10, the water to be treated line 20, and the membrane filtration treated water line 22, as a reducing agent addition unit for adding a reducing agent.

Operations of the water treatment method and water treatment device 1 according to embodiments of the present invention are described below.

In the water treatment device 1 of FIG. 1, the water to be treated containing at least one of a chlorine-based oxidizing agent and a bromine-based oxidizing agent passes through the water to be treated line 18, and following storage in the water to be treated tank 10 where necessary, is passed through the water to be treated line 20 and fed into the membrane filtration device 12. In the membrane filtration device 12, a membrane filtration treatment of the water to be treated is conducted using a separation membrane (a membrane filtration treatment step). The membrane filtration treated water obtained in the membrane filtration treatment step is passed through the membrane filtration treated water line 22 and fed into the reverse osmosis membrane device 14. In the reverse osmosis membrane device 14, the membrane filtration treated water is subjected to a reverse osmosis membrane treatment using a reverse osmosis membrane to obtain a permeate and a concentrate (a reverse osmosis membrane treatment step). The permeate is discharged through the permeate line 24, and the concentrate is discharged through the concentrate line 26.

In the case where the water treatment device 1 does not include the membrane filtration device 12, the water to be treated containing at least one of a chlorine-based oxidizing agent and a bromine-based oxidizing agent is fed into the reverse osmosis membrane device 14, and in the reverse osmosis membrane device 14, the water to be treated is subjected to a reverse osmosis membrane treatment using a reverse osmosis membrane to obtain a permeate and a concentrate (a reverse osmosis membrane treatment step).

In the water treatment method and the water treatment device 1 according to embodiments of the present invention, in the case where the water treatment device 1 includes the membrane filtration device 12 and the membrane filtration treatment step is conducted, for each 1 mol of free chlorine and free bromine in the water to be treated in the membrane filtration treatment step, which contains at least one of a chlorine-based oxidizing agent and a bromine-based oxidizing agent, at least 2 mol of the slime-suppressing auxiliary agent for a reverse osmosis membrane is added through the slime-suppressing auxiliary agent addition line 28 to the water to be treated (a slime-suppressing auxiliary agent addition step). In the case where the water treatment device 1 does not include the membrane filtration device 12, for each 1 mol of free chlorine and free bromine in the water to be treated in the reverse osmosis membrane treatment step, which contains at least one of a chlorine-based oxidizing agent and a bromine-based oxidizing agent, at least 2 mol of the slime-suppressing auxiliary agent is added through the slime-suppressing auxiliary agent addition line 28 (a slime-suppressing auxiliary agent addition step). In this description, “at least one of a chlorine-based oxidizing agent and a bromine-based oxidizing agent” is sometimes simply described using the expression “a chlorine-based oxidizing agent or the like”. At least one of a chlorine-based oxidizing agent and a bromine-based oxidizing agent may be added to the water to be treated containing no chlorine-based oxidizing agent or bromine-based oxidizing agent, either before or after the addition of the slime-suppressing auxiliary agent, or an additional amount of at least one of a chlorine-based oxidizing agent and a bromine-based oxidizing agent may be added to the water to be treated containing at least one of a chlorine-based oxidizing agent and a bromine-based oxidizing agent, either before or after the addition of the slime-suppressing auxiliary agent. In these cases, one or more oxidizing agent addition lines may be provided for adding at least one of a chlorine-based oxidizing agent and a bromine-based oxidizing agent.

By adding the slime-suppressing auxiliary agent for a reverse osmosis membrane to the water to be treated in the reverse osmosis membrane treatment, which contains a chlorine-based oxidizing agent or the like, the chlorine-based oxidizing agent or the like which can cause degradation of the reverse osmosis membrane can be reduced. The chlorine-based oxidizing agent or the like oxidizes the slime-suppressing auxiliary agent for a reverse osmosis membrane to form iodine having sterilizing power, thereby converting the slime-suppressing auxiliary agent into a slime inhibitor that inhibits slime formation while causing almost no degradation of the reverse osmosis membrane. As a result, by adding the slime-suppressing auxiliary agent for a reverse osmosis membrane to the water to be treated containing the chlorine-based oxidizing agent or the like, degradation of the reverse osmosis membrane can be suppressed, and slime formation can also be suppressed.

The location at which the slime-suppressing auxiliary agent for a reverse osmosis membrane is added to the water to be treated containing the chlorine-based oxidizing agent or the like may be any one of the water to be treated line 18, the water to be treated tank 10, the water to be treated line 20 upstream from the membrane filtration device 12, and the membrane filtration treated water line 22 downstream from the membrane filtration device 12. In terms of factors such as suppressing degradation of the membrane filtration device 12 by the chlorine-based oxidizing agent or the like, the slime-suppressing auxiliary agent is preferably added to the water to be treated in the membrane filtration treatment step, namely, either to the water to be treated tank 10, or to the water to be treated line 20 upstream from the membrane filtration device 12.

The chlorine-based oxidizing agent or bromine-based oxidizing agent may be any oxidizing agent having an oxidation-reduction potential (ORP) higher than that of iodine, and although similar effects can be achieved with combined chlorine or a stabilized hypobromous acid composition containing a sulfamic acid compound and a bromine-based oxidizing agent such as bromine, in terms of reaction speed and the like, oxidizing agents in a form that can be detected as free chlorine are preferred, with representative examples of these oxidizing agents having a form that can be detected as free chlorine including hypochlorous acid, hypobromous acid, and salts of these acids.

In this description, the oxidizing power of an oxidizing agent is represented as the total chlorine or free chlorine determined by the DPD method. In this description, the term “total chlorine” refers to a concentration determined by absorption spectrophotometry using N,N-diethyl-p-phenylenediammonium sulfate (DPD) as disclosed in section 33 “Residual Chlorine” in JIS K 0120:2013. In one example, 2.5 mL of a 0.2 mol/L potassium dihydrogen phosphate solution is placed in a 50 mL colorimetric tube, 0.5 g of a dilute powder of DPD (prepared by crushing 1.0 g of N,N-diethyl-p-phenylenediammonium sulfate and then mixing the powder with 24 g of sodium sulfate) is added, 0.5 g of potassium iodide is added, an appropriate amount of the sample is added, water is then added to bring the volume up to the marked line and dissolve the mixture, and the resulting solution is left to stand for about three minutes. The absorbance of the resulting pink to pinky red color is measured near a wavelength of 510 nm (or 555 nm) and used to quantify the oxidizing agent. Furthermore, in this description, the term “free chlorine” refers to the oxidizing power of the oxidizing agent determined by conducting a measurement in the above “total chlorine” measurement method without adding the potassium iodide.

The DPD is oxidized by oxidizing agents, and examples of oxidizing agents that can be measured include chlorine, bromine, iodine, hydrogen peroxide, and ozone and the like. Chlorine forms that are quantified as total chlorine include all forms having oxidizing power, including hypochlorous acid, hypochlorite ions, chlorine, and combined chlorine such as chloramine and dichloramine. In a similar manner, all forms of bromine or iodine that have oxidizing power can be measured. Substances that are quantified as free chlorine include all forms that can be measured in the above “total chlorine” measurement method without adding the potassium iodide, and examples include hypochlorous acid, hypobromous acid, chlorine, bromine and iodine.

Further, “total chlorine” can be converted to “total iodine”. Specifically, a conversion may be made based on the “molecular weight of chlorine” and the “molecular weight of iodine”. In other words, “total chlorine”×(253.8/70.9)≈“total chlorine”×3.58 =“total iodine”. In a similar manner, “free chlorine” can be converted to “free iodine”.

In the slime-suppressing auxiliary agent addition step, the method used for adding the slime-suppressing auxiliary agent for a reverse osmosis membrane to the water to be treated may be either a continuous addition in which the slime-suppressing auxiliary agent for a reverse osmosis membrane is added continuously to the water to be treated, or an intermittent addition that provides an addition period during which the slime-suppressing auxiliary agent for a reverse osmosis membrane is added to the water to be treated, and a non-addition period during which the slime-suppressing auxiliary agent for a reverse osmosis membrane is not added to the water to be treated. In terms of chemical costs and the like, intermittent addition is preferred.

In the slime-suppressing auxiliary agent addition step, intermittent addition in which the addition period is a continuous period of at least 10 seconds but not more than 12 hours, and the non-addition period is a continuous period of at least 5 seconds but not more than 320 hours is preferred.

Furthermore, it is preferable that a reducing agent is added during this non-addition period. As illustrated in FIG. 2, the reducing agent is passed through the reducing agent addition line 30 and is added to the water to be treated in the membrane filtration treatment step, or to the water to be treated in the reverse osmosis membrane treatment step (the membrane filtration treated water) (a reducing agent addition step). The location at which the reducing agent is added to the water to be treated during the non-addition period may be any one of the water to be treated line 18, the water to be treated tank 10, the water to be treated line 20 upstream from the membrane filtration device 12, and the membrane filtration treated water line 22 downstream from the membrane filtration device 12. The addition location for the reducing agent may be upstream or downstream from the addition location for the slime-suppressing auxiliary agent, but is preferably upstream from the addition location for the slime-suppressing auxiliary agent.

In those cases where a reducing agent is not added during the non-addition period, degradation of the reverse osmosis membrane may sometimes arise. Examples of the reducing agent include sulfite salts such as sodium sulfite, bisulfite salts such as sodium bisulfite, thiosulfate salts such as sodium thiosulfate, as well as hydrazine, hydroxylamine and hydrogen sulfide. Among these, from the viewpoint of safety and the like, sulfite salts, bisulfite salts and thiosulfate salts are preferred, and thiosulfate salts are particularly preferred.

As shown below in formulas (1) and (2), in the case of a sulfite salt or bisulfite salt, free iodine reacts with the reducing agent in an equimolar ratio, whereas in the case of a thiosulfate salt, as shown in formula (3), the free iodine reacts with the reducing agent in a ½ molar ratio. If some reducing agent added during the non-addition period is retained, then the reducing agent reduces the free iodine produced during the addition period, but by using a thiosulfate salt, the amount of this reduction can be suppressed compared with the case of a sulfite salt or bisulfite salt.

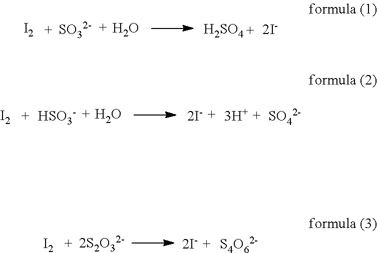

The amount added of the iodide ions is preferably controlled so that the oxidation-reduction potential (ORP) of the water to be treated in the reverse osmosis membrane treatment following the addition of at least 2 mol of iodide ions per 1 mol of free chlorine and free bromine in the water to be treated containing the chlorine-based oxidizing agent or the like is not more than 800 mV. This oxidation-reduction potential is preferably not more than 750 mV, and more preferably 700 mV or less. If this oxidation-reduction potential exceeds 800 mV, then degradation of the reverse osmosis membrane may occur. The amount added of the iodide ions to the water to be treated can be easily managed via the pH and the oxidation-reduction potential. For example, in those cases where iodide ions are added as the slime-suppressing auxiliary agent for a reverse osmosis membrane containing water and an iodide, even if the amount of free chlorine in the water to be treated is not stable, the amount of iodide ions added to the water to be treated can still be managed via the pH and the oxidation-reduction potential.

The slime-suppressing auxiliary agent for a reverse osmosis membrane added to the water to be treated may be added in any way that ensures that the amount of iodide ions is at least 2 mol per 1 mol of free chlorine and free bromine. If the slime-suppressing auxiliary agent for a reverse osmosis membrane added to the water to be treated yields less than 2 mol of iodide ions per 1 mol of free chlorine and free bromine, then degradation of the reverse osmosis membrane may sometimes occur.

The slime-suppressing auxiliary agent for a reverse osmosis membrane may be added in the form of a solid iodide such as sodium iodide or potassium iodide, may be added in the form of an aqueous solution prepared in advance by dissolving an iodide such as sodium iodide or potassium iodide in water, or may be added in the form of an aqueous solution already containing free iodine, which can be prepared by dissolving iodine in an aqueous solution containing a dissolved iodide such as sodium iodide or potassium iodide. From the viewpoint of handling and the like, the slime-suppressing auxiliary agent is preferably added as an aqueous solution, and from the viewpoint of the storage properties and the like, addition in the form of an aqueous solution that does not contain free iodine is more preferred.

### Slime-Suppressing Auxiliary Agent for Reverse Osmosis Membrane

A slime-suppressing auxiliary agent for a reverse osmosis membrane that can be used in the water treatment method according to an embodiment of the present invention is a composition containing an iodide, an alkali agent and water, and having a free iodine concentration of 0.1 mg/L or less.

The slime-suppressing auxiliary agent for a reverse osmosis membrane according to an embodiment of the present invention contains an iodide, an alkali agent and water, the iodide ion concentration in the slime-suppressing auxiliary agent for a reverse osmosis membrane is preferably at least 3.8% but less than 20%, and the pH of the slime-suppressing auxiliary agent for a reverse osmosis membrane is preferably 8 or higher.

The slime-suppressing auxiliary agent for a reverse osmosis membrane according to an embodiment of the present invention is a composition which has a free iodine concentration of 0.1 mg/L or less, contains an iodide, and exhibits good suppression of the release of free iodine. The free iodine concentration of the slime-suppressing auxiliary agent for a reverse osmosis membrane is preferably 0.05 mg/L or less, and is preferably as low as possible. If the free iodine concentration of the slime-suppressing auxiliary agent for a reverse osmosis membrane exceeds 0.1 mg/L, then attention may be paid to the material and the like used for the tanks and addition lines that are used.

The color of the slime-suppressing auxiliary agent for a reverse osmosis membrane according to an embodiment of the present invention is, for example, typically 5 units or lower, and is preferably below the limit of detection.

The iodide incorporated in the slime-suppressing auxiliary agent for a reverse osmosis membrane is an inorganic salt of iodine, and examples include potassium iodide, sodium iodide, lithium iodide, copper iodide and zinc iodide, although from the perspective of cost and the like, potassium iodide or sodium iodide is preferred. The slime-suppressing auxiliary agent for a reverse osmosis membrane may contain a single type of iodide, or may contain two or more types of iodide.

The iodide ion concentration in the slime-suppressing auxiliary agent for a reverse osmosis membrane is preferably less than 20% by mass, more preferably at least 1% by mass but less than 20% by mass, even more preferably at least 3.8% by mass but less than 20% by mass, still more preferably at least 10% by mass but less than 20% by mass, particularly preferably at least 15% by mass but less than 20% by mass, and most preferably at least 15% by mass but not more than 19% by mass. If the iodide ion concentration is less than 1% by mass, then the increase in the amount of the slime-suppressing auxiliary agent that must be used tends to cause an increase in usage costs associated with the transport, storage, and addition and the like of the slime-suppressing auxiliary agent, whereas if the concentration exceeds 20% by mass, and in particular if the concentration exceeds 19% by mass, free iodine is more likely to be produced during high-temperature storage, and the amount of the alkali agent required to ensure no production of free iodine may sometimes increase.

The alkali agent incorporated in the slime-suppressing auxiliary agent may be any substance capable of adjusting the pH of the solution, and examples include hydroxides such as sodium hydroxide, potassium hydroxide, calcium hydroxide, ammonium hydroxide and tetramethylammonium hydroxide, carbonate salts such as sodium carbonate and potassium carbonate, and bicarbonate salts such as sodium bicarbonate and potassium bicarbonate. Among these, from the viewpoints of safety and production costs and the like, hydroxides such as sodium hydroxide, potassium hydroxide and calcium hydroxide are preferred, and sodium hydroxide or potassium hydroxide is particularly preferred.

Furthermore, from the viewpoint of the storage stability and the like, the amount of the alkali agent in the slime-suppressing auxiliary agent for a reverse osmosis membrane is preferably at least 0.01% by mass, and more preferably 0.02% by mass or greater. The upper limit for the amount of the alkali agent is, for example, less than 10% by mass, and is preferably less than 1% by mass.

The pH of the slime-suppressing auxiliary agent for a reverse osmosis membrane is preferably 8 or higher, and more preferably 12 or higher. If the pH of the slime-suppressing auxiliary agent for a reverse osmosis membrane is less than 8, then free iodine may sometimes be produced. The upper limit for the pH of the slime-suppressing auxiliary agent for a reverse osmosis membrane is, for example, 14 or lower.

The water is, for example, a water having a free chlorine concentration of 0.2 mg/L or less, and examples include pure water and ultrapure water.

The slime-suppressing auxiliary agent for a reverse osmosis membrane according to an embodiment of the present invention can be used favorably as a water treatment agent for functions such as reducing residual chlorine in a water to be treated or sterilizing a water to be treated. The iodide ions incorporated in the slime-suppressing auxiliary agent for a reverse osmosis membrane can effectively reduce and detoxify any residual chlorine. The slime-suppressing auxiliary agent for a reverse osmosis membrane according to an embodiment of the present invention can be used particularly favorably as a sterilization assistant in a reverse osmosis membrane treatment.

In water treatment devices, an oxidizing agent such as hypochlorous acid or hypobromous acid is generally added for the purposes of sterilization and suppression of slime formation. However, it is known that when these oxidizing agents are not fully consumed for these purposes of sterilization and suppression of slime formation and are retained in the water to be treated, inflow into the downstream water treatment device can have adverse effects on those downstream water treatment devices. This inflow of residual chlorine or the like can, for example, cause corrosion in cooling towers, cause degradation in the performance of the reverse osmosis membrane in reverse osmosis membrane devices, and cause marked oxidative degradation in resin towers or electrodeionization (EDI) systems.

The slime-suppressing auxiliary agent for a reverse osmosis membrane according to an embodiment of the present invention can suppress these types of adverse effects on downstream water treatment devices, and can suppress corrosion in cooling towers, degradation in the performance of the reverse osmosis membrane in reverse osmosis membrane devices, and oxidative degradation in resin towers or electrodeionization (EDI) systems.

In those cases where the slime-suppressing auxiliary agent for a reverse osmosis membrane described above is used in a water treatment, the slime-suppressing auxiliary agent for a reverse osmosis membrane may be added, for example, to the water to be treated containing at least one of a chlorine-based oxidizing agent and a bromine-based oxidizing agent. Further, in a water treatment method in which a water to be treated containing at least one of a chlorine-based oxidizing agent and a bromine-based oxidizing agent is treated using a reverse osmosis membrane, the slime-suppressing auxiliary agent for a reverse osmosis membrane may be added to the water to be treated.

By adding an iodide to a water to be treated by a reverse osmosis membrane treatment or the like containing at least one of a chlorine-based oxidizing agent and a bromine-based oxidizing agent, any chlorine-based oxidizing agent or the like that may possibly cause degradation of the reverse osmosis membrane or the like can be reduced. The slime-suppressing auxiliary agent for a reverse osmosis membrane is oxidized by the chlorine-based oxidizing agent or the like to form iodine which has sterilizing power, thereby converting the auxiliary agent into a slime inhibitor that inhibits slime formation while causing almost no degradation of the reverse osmosis membrane or the like. As a result, by adding the above slime-suppressing auxiliary agent for a reverse osmosis membrane to the water to be treated containing the chlorine-based oxidizing agent or the like, degradation of the reverse osmosis membrane can be suppressed, and slime formation can also be suppressed.

### Method for Producing Slime-Suppressing Auxiliary Agent for Reverse Osmosis Membrane

The slime-suppressing auxiliary agent for a reverse osmosis membrane used in the water treatment method according to an embodiment of the present invention can be produced using a method that includes an addition step of adding an iodide and an alkali agent to a water having a free chlorine concentration of 0.2 mg/L or less. Further, the slime-suppressing auxiliary agent for a reverse osmosis membrane used in the water treatment method according to an embodiment of the present invention can also be produced using a method that includes a removal step of removing free chlorine from a water having a free chlorine concentration exceeding 0.2 mg/L to achieve a free chlorine concentration of 0.2 mg/L or less, and an addition step of adding an iodide and an alkali agent to the water from which the free chlorine has been removed.

There are no particular limitations on the method used for removing free chlorine from a water having a free chlorine concentration exceeding 0.2 mg/L to achieve a free chlorine concentration of 0.2 mg/L or less, and example include methods using activated carbon, and methods using a reducing agent such as sodium bisulfite, although in those cases where a reducing agent is used, the reducing agent may be added in excess to deal with changes in the free chlorine concentration, and therefore removing the free chlorine with activated carbon is preferred.

Examples of the water having a free chlorine concentration exceeding 0.2 mg/L used as the raw material for the removal step include tap water and the like.

The free chlorine concentration of the water used in the addition step, or the free chlorine concentration of the water from which free chlorine has been removed to reduce the free chlorine concentration obtained in the removal step may be any value of 0.2 mg/L or less, but is preferably 0.1 mg/L or less, and more preferably as low as possible.

In the addition step, for example, the iodide and alkali agent may be added at a temperature within a range from 0 to 50° C. to the water from which free chlorine has been removed. There are no particular limitations on the sequence in which the iodide and the alkali agent are added. If necessary, following the addition of the iodide and alkali agent to the water from which free chlorine has been removed, stirring may be conducted using a stirring device or the like. The storage temperature for the resulting slime-suppressing auxiliary agent for a reverse osmosis membrane is, for example, typically within a range from −5 to 50° C.

By using this method for producing a slime-suppressing auxiliary agent for a reverse osmosis membrane, a slime-suppressing auxiliary agent for a reverse osmosis membrane can be obtained which contains an iodide and exhibits good suppression of the release of free iodine.

The present invention includes the following embodiments.
[1] A method for producing a slime-suppressing auxiliary agent for a reverse osmosis membrane, the method including an addition step of adding an iodide and an alkali agent to a water having a free chlorine concentration of 0.2 mg/L or less.
[2] A method for producing a slime-suppressing auxiliary agent for a reverse osmosis membrane, the method including:
a removal step of removing free chlorine from a water having a free chlorine concentration exceeding 0.2 mg/L to reduce the free chlorine concentration to 0.2 mg/L or less, and
an addition step of adding an iodide and an alkali agent to the water from which free chlorine has been removed.
[3] A slime-suppressing auxiliary agent for a reverse osmosis membrane, the slime-suppressing auxiliary agent containing an iodide, an alkali agent and water, and having a free iodine concentration of 0.1 mg/L or less.
[4] The slime-suppressing auxiliary agent for a reverse osmosis membrane according to [3], wherein
the iodide ion concentration is at least 3.8% but less than 20%.
[5] The slime-suppressing auxiliary agent for a reverse osmosis membrane according to [3] or [4],
having a pH of 8 or higher.
[6] A water treatment method including:
a reverse osmosis membrane treatment step of treating a water to be treated containing at least one of a chlorine-based oxidizing agent and a bromine-based oxidizing agent using a reverse osmosis membrane to obtain a concentrate and a permeate, wherein
the slime-suppressing auxiliary agent for a reverse osmosis membrane according to any one of [3] to [5] is introduced into the water to be treated such that the amount of iodide ions is at least 2 mol per 1 mol of free chlorine and free bromine in the water to be treated.
[7] A water treatment method including:
a membrane filtration treatment step of subjecting a water to be treated containing at least one of a chlorine-based oxidizing agent and a bromine-based oxidizing agent to a membrane filtration treatment using a separation membrane, and
a reverse osmosis membrane treatment step of treating the membrane filtration treated water obtained in the membrane filtration treatment step using a reverse osmosis membrane to obtain a concentrate and a permeate, wherein
the slime-suppressing auxiliary agent for a reverse osmosis membrane according to any one of [3] to [5] is introduced into the water to be treated in the membrane filtration treatment step such that the amount of iodide ions is at least 2 mol per 1 mol of free chlorine and free bromine in the water to be treated.

### EXAMPLES

The present invention is described below in specific detail using a series of examples and a comparative example, but the present invention is not limited to the following examples.

### Example 1

The free iodine concentration of a slime-suppressing auxiliary agent for a reverse osmosis membrane was measured for a series of waters having different free chlorine concentrations used in the production of the slime-suppressing auxiliary agent for a reverse osmosis membrane. The color value increases with increasing free iodine in the composition, and therefore the color was also measured.

A prescribed amount of sodium hypochlorite was added to an ultrapure water having a free chlorine concentration of less than 0.02 mg/L, thereby adjusting the free chlorine concentration to a prescribed concentration. Potassium iodide (20% by mass) was added as an iodide to this water having a prescribed residual chlorine concentration (80% by mass). No alkali agent was included as a pH modifier. The ultrapure water was prepared using Sagamihara well water having a free chlorine concentration of less than 002 mg/L, which was then treated with a desalting unit such as an ion exchange resin or a reverse osmosis membrane.

The color of each of the obtained compositions was measured using the method disclosed at the URL: https://www.toadkk.co.jp/support/hach/runbook/f6idue00000036jm-att/8025_Pt-.Co.pdf

The free iodine was quantified using the DPD method.

The results are shown in Table 1.

TABLE 1

| Free chlorine | Iodide ions | Color | Free iodine |
|---|---|---|---|
| mg/L | % by mass | units Pt—Co^{※} | mg/L |
| 0.5 | 15.3 | 8 | 0.90 |
| 0.25 | 15.3 | 5 | 0.14 |
| 0.2 | 15.3 | <5 | <0.05 |
| 0.1 | 15.3 | <5 | <0.05 |
| 0 | 15.3 | <5 | <0.05 |

^{※}1 mg/L of platinum contained in a chloroplatinate is equivalent to 1 unit

When the free chlorine concentration contained in the water used in the production of the slime-suppressing auxiliary agent for a reverse osmosis membrane was 0.2 mg/L or less, the free iodine concentration was less than the detection limit (<0.05 mg/L), and the color was less than 5 units.

### Example 2

### Evaluation of Long-Term Storage Stability

Potassium iodide was added as an iodide at 25° C. in the blend amounts shown in Table 2, Table 3, Table 4 and Table 5 to ultrapure water samples having a free chlorine concentration of less than 0.02 mg/L. The pH of each composition was adjusted using either hydrochloric acid or an aqueous solution of sodium hydroxide. The free iodine concentration of each obtained compositions (slime-suppressing auxiliary agent for a reverse osmosis membrane) was less than 0.05 mg/L. The free iodine concentration following storage at 25° C. for 30 days, or at 50° C. for 30 days, was quantified by DPD. The results are shown in Table 6 and Table 7 respectively.

TABLE 2
Composition table

| | | | | | | | | | |
|---|---|---|---|---|---|---|---|---|---|
| Composition | Potassium iodide | 30 | 30 | 30 | 30 | 30 | 30 | 30 | 30 |
| [% by mass] | 0.35% HCl | 0.0430 | 0.0250 | 0.0100 | 0.00500 | — | — | — | — |
| | 0.48% KOH | — | — | — | — | — | 0.0300 | 0.190 | 1.74 |
| | Water | 70.0 | 70.0 | 70.0 | 70.0 | 70.0 | 70.0 | 69.8 | 68.3 |
| | Total | 100 | 100 | 100 | 100 | 100 | 100 | 100 | 100 |
| Physical | Iodide ions | 22.9 | 22.9 | 22.9 | 22.9 | 22.9 | 22.9 | 22.9 | 22.9 |
| properties | [% by mass] | | | | | | | | |
| | pH | 4.96 | 6.01 | 6.97 | 7.95 | 9.01 | 10.01 | 11.01 | 12.00 |

TABLE 3

| | | | |
|---|---|---|---|
| Composition | Potassium iodide | 25 | 25 |
| [% by mass] | 0.35% HCl | — | — |
| | 0.48% KOH | 0.685 | 6.59 |
| | Water | 74.3 | 68.4 |
| | Total | 100 | 100 |
| Physical | Iodide ions [% by mass] | 19.1 | 19.1 |
| properties | pH | 11.00 | 12.00 |

TABLE 4

| | | | | | | | | | |
|---|---|---|---|---|---|---|---|---|---|
| Composition | Potassium iodide | 20 | 20 | 20 | 20 | 20 | 20 | 20 | 20 |
| [% by mass] | 0.35% HCl | 0.0250 | 0.0150 | 0.00500 | 0.00200 | — | — | — | — |
| | 0.48% KOH | — | — | — | — | 0.00500 | 0.0350 | 0.230 | 2.25 |
| | Water | 80.0 | 80.0 | 80.0 | 80.0 | 80.0 | 80.0 | 79.8 | 77.8 |
| | Total | 100 | 100 | 100 | 100 | 100 | 100 | 100 | 100 |
| Physical | Iodide ions | 15.3 | 15.3 | 15.3 | 15.3 | 15.3 | 15.3 | 15.3 | 15.3 |
| properties | [% by mass] | | | | | | | | |
| | pH | 4.99 | 6.02 | 6.95 | 7.97 | 9.04 | 10.02 | 10.99 | 12.00 |

TABLE 5

| | | | | | | | | | |
|---|---|---|---|---|---|---|---|---|---|
| Composition | Potassium iodide | 5 | 5 | 5 | 5 | 5 | 5 | 5 | 5 |
| [% by mass] | 0.35% HCl | 0.0100 | 0.0030 | — | — | — | — | — | — |
| | 0.48% KOH | — | — | 0.003 | 0.01 | 0.01500 | 0.0500 | 0.360 | 3.44 |
| | Water | 95.0 | 95.0 | 95.0 | 95.0 | 95.0 | 95.0 | 94.6 | 91.6 |
| | Total | 100 | 100 | 100 | 100 | 100 | 100 | 100 | 100 |
| Physical | Iodide ions | 3.8 | 3.8 | 3.8 | 3.8 | 3.8 | 3.8 | 3.8 | 3.8 |
| properties | [% by mass] | | | | | | | | |
| | pH | 4.95 | 5.95 | 7.00 | 7.98 | 9.01 | 10.00 | 11.00 | 12.00 |

TABLE 6
Long-term storage stability (25° C., 30 days)

| Free iodine | | Iodide ion content [% by mass] | | |
|---|---|---|---|---|
| [mg/100 g] | | 3.8 | 15.3 | 22.9 |
| pH | 12 | <0.13 | <0.13 | <0.13 |
| | 11 | <0.13 | <0.13 | <0.13 |
| | 10 | <0.13 | <0.13 | <0.13 |
| | 9 | <0.13 | <0.13 | <0.13 |
| | 8 | <0.13 | <0.13 | <0.13 |
| | 7 | 0.23 | <0.13 | 0.13 |
| | 6 | <0.13 | <0.13 | 0.15 |
| | 5 | 0.15 | 0.13 | 0.18 |

TABLE 7
Long-term storage stability (50° C., 30 days)

| | |
|---|---|
| Free iodine | Iodide ion content [% by mass] |

| | | | | |
|---|---|---|---|---|
| [mg/100 g] | 3.8 | 15.3 | 19.1 | 22.9 |

| | | | | | |
|---|---|---|---|---|---|
| pH | 12 | <0.13 | <0.13 | <0.13 | 0.73 |
| | 11 | 0.13 | 0.80 | 1.23 | 1.88 |
| | 10 | 0.18 | 0.88 | — | 1.88 |
| | 9 | 0.20 | 0.95 | — | 2.00 |
| | 8 | 0.18 | 0.83 | — | 1.95 |
| | 7 | 0.23 | 0.80 | — | 1.95 |
| | 6 | 0.18 | 1.00 | — | 2.03 |
| | 5 | 0.23 | 1.00 | — | 2.18 |

In the case of storage at 25° C. for 30 days, the storage stability was favorable at composition pH levels of 8 or higher. In the case of storage at 50° C. for 30 days, the storage stability was favorable at composition pH levels of 12 or higher.

### Example 3, Reference Examples 1 and 2

### Evaluation of Sterilization Effect

A mixture of the slime-suppressing auxiliary agent for a reverse osmosis membrane (a potassium iodide (KI) aqueous solution) and sodium hypochlorite (NaClO) as the example, sodium hypochlorite alone as one reference example, and an iodine-based oxidizing agent (the oxidizing agent disclosed in WO2021/192582) as another reference example were each added to a simulated water to achieve the concentrations listed below, and the sterilization effects of the compositions were then compared. The simulated water was prepared by adding bouillon to Sagamihara well water that had undergone a dechlorination treatment to achieve a bacterial count of 10⁷. The bacterial count was measured using a San-Ai Biochecker TTC (manufactured by San-Ai Oil Co., Ltd.). The results are shown in Table 8.

Sodium Hypochlorite (Reference Example 1): 1.0 mg/L

A mixture of 1.0 mg/L of sodium hypochlorite, and 4.5 mg/L of potassium iodide as a slime-suppressing auxiliary agent for a reverse osmosis membrane (potassium iodide aqueous solution) with a free iodine concentration of less than 0.05 mg/L (equivalent to 22.5 mg/L as an auxiliary agent) (Example 3)

An Iodine-Based Oxidizing Agent (Reference Example 2): 1.0 mg/L as Cl₂ (see WO2021/192582)

TABLE 8

| | | | | | | | Iodine-based | | |
|---|---|---|---|---|---|---|---|---|---|
| | NaClO | | | NaClO + KI | | | oxidizing agent | | |
| pH at test start | 4 | 7 | 10 | 4 | 7 | 10 | 4 | 7 | 10 |
| Bacterial count at test start | 10\hat{ }7 | 10\hat{ }7 | 10\hat{ }7 | 10\hat{ }7 | 10\hat{ }7 | 10\hat{ }7 | 10\hat{ }7 | 10\hat{ }7 | 10\hat{ }7 |
| Bacterial count 10 minutes | <10\hat{ }3 | 10\hat{ }3 | 10\hat{ }7 | <10\hat{ }3 | <10\hat{ }3 | <10\hat{ }3 | <10\hat{ }3 | <10\hat{ }3 | <10\hat{ }3 |
| after agent addition | | | | | | | | | |
| Bacterial count one hour | — | <10\hat{ }3 | <10\hat{ }3 | — | — | — | — | — | — |
| after agent addition | | | | | | | | | |

When the mixture of the slime-suppressing auxiliary agent for a reverse osmosis membrane (potassium iodide aqueous solution) and sodium hypochlorite from the example was used, the sterilization effect was superior to that of sodium hypochlorite alone, and similar to that of the iodine-based oxidizing agent disclosed in WO2021/192582.

### Example 4, Reference Examples 3 and 4

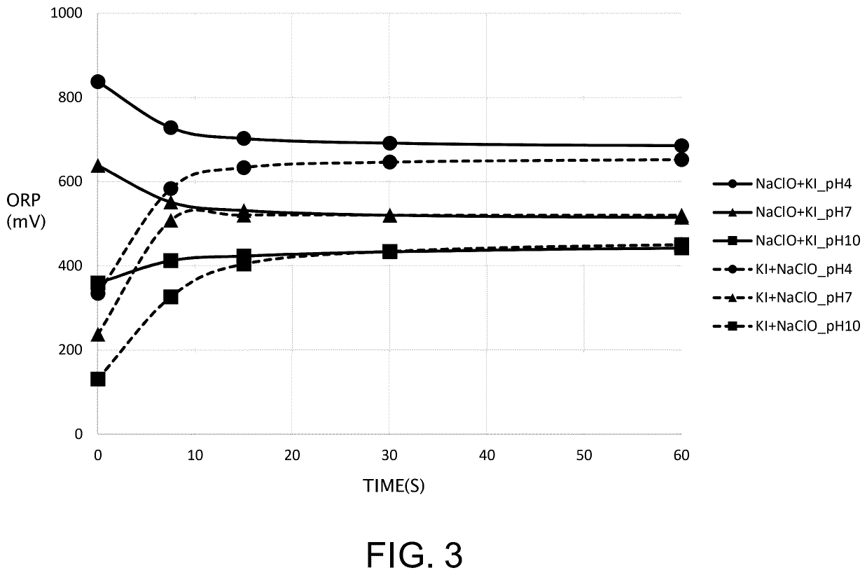

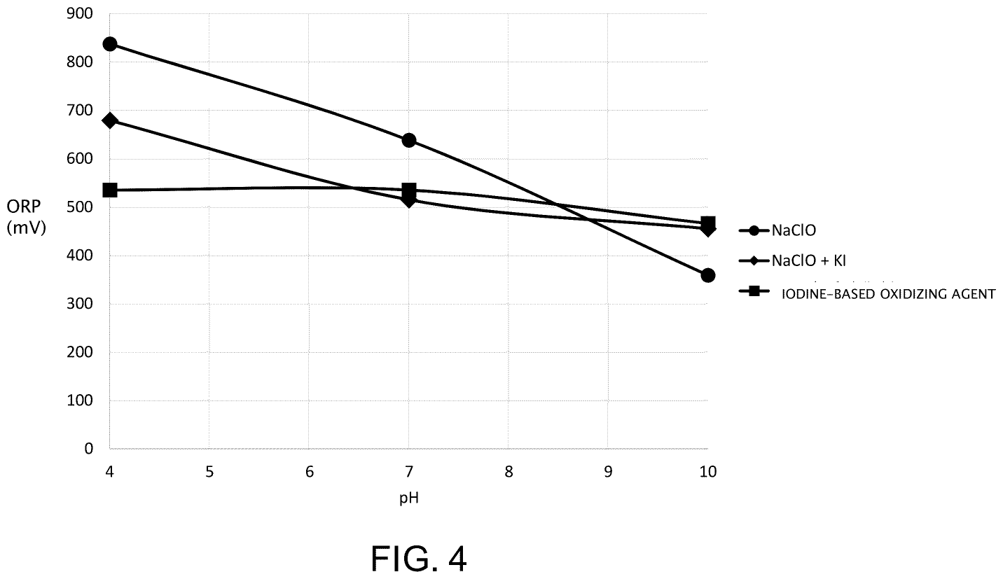

### Measurement of Oxidation-Reduction Potential (ORP) (FIG. 3 and FIG. 4)

A mixture of the slime-suppressing auxiliary agent for a reverse osmosis membrane (a potassium iodide (KI) aqueous solution) and sodium hypochlorite (NaClO) as the example was added to an ultrapure water, and the oxidation-reduction potential (ORP) was measured. FIG. 3 illustrates the results when sodium hypochlorite was added first and the slime-suppressing auxiliary agent for a reverse osmosis membrane (potassium iodide aqueous solution) was added afterward at pH levels of 4, 7 or 10 (the solid lines), and the results when the slime-suppressing auxiliary agent for a reverse osmosis membrane (potassium iodide aqueous solution) was added first and sodium hypochlorite was added afterward at pH levels of 4, 7 or 10 (the dashed lines). FIG. 4 illustrates the results of adding the slime-suppressing auxiliary agent for a reverse osmosis membrane and sodium hypochlorite from the example, sodium hypochlorite alone as one reference example, and an iodine-based oxidizing agent (the oxidizing agent disclosed in WO2021/192582) as another reference example at pH levels of 4, 7 or 10 to achieve the concentrations listed below.

Sodium Hypochlorite (Reference Example 3): 1.0 mg/L

A mixture of 1.0 mg/L of sodium hypochlorite, and 4.5 mg/L of potassium iodide as a slime-suppressing auxiliary agent for a reverse osmosis membrane (potassium iodide aqueous solution) with a free iodine concentration of less than 0.05 mg/L (equivalent to 22.5 mg/L as an auxiliary agent) (Example 4)

An Iodine-Based Oxidizing Agent (Reference Example 4): 1.0 mg/L as Cl₂ (see WO2021/192582)

Solid lines: NaClO added first, KI added afterward

Dashed lines: KI added first, NaClO added afterward

It was evident that the amount added of the iodide ions needed to be controlled such that the oxidation-reduction potential (ORP) of the water to be treated was no greater than 800 mV.

### Example 5, Comparative Example 1

### Effects on Membrane

The effects on a reverse osmosis membrane were evaluated for the case where the mixture of the slime-suppressing auxiliary agent for a reverse osmosis membrane (potassium iodide aqueous solution (KI)) and sodium hypochlorite (NaClO) from the example was used. The results are shown in Table 9.

### Test Procedure

1. The flux and EC rejection rate of the reverse osmosis membrane are measured prior to contact with the agent
2. The agent is brought into contact with the reverse osmosis membrane at a theoretical value for the CT value of 30,000 (mg/L as Cl²×h)
3. The flux and EC rejection rate of the reverse osmosis membrane are measured following the contact with the agent

The flux was calculated by dividing the permeate volume per prescribed time period at 25° C. by the membrane surface area and the operating pressure. The EC rejection rate was determined by measuring the conductivity of the permeate and the conductivity of the feed water using a conductivity measurement apparatus, with the EC rejection rate calculated as (100−[permeate conductivity/feed water conductivity]×100).

### Test Conditions

Reverse osmosis membrane test device
Reverse osmosis membranes: reverse osmosis flat membranes (ESPA2, LFC3) manufactured by Nitto Denko Corporation
Feed water: pure water+NaCl, water temperature: 25° C., pressure: 0.75 MPa, supply rate: 5 L/min
NaCl: 500 mg/L
Sodium hypochlorite (Comparative Example 1): 0.30 g/L
A mixture of 0.30 g/L of sodium hypochlorite, and 1.35 g/L of potassium iodide as a slime-suppressing auxiliary agent for a reverse osmosis membrane (potassium iodide aqueous solution) with a free iodine concentration of less than 0.05 mg/L (equivalent to 6.75 g/L as an auxiliary agent) (Example 5)

TABLE 9

| | | | Flux [m/(d · MPa)] | | EC rejection rate [%] | |
|---|---|---|---|---|---|---|
| | Membrane | | before | after | before | after |
| | type | pH | contact | contact | contact | contact |
| NaClO + | ESPA2 | 4 | 1.5 | 1.4 | 98.9 | 99.1 |
| KI | | 7 | 1.5 | 1.6 | 99.1 | 98.9 |
| | LFC3 | 4 | 0.9 | 0.9 | 99.3 | 98.3 |
| | | 7 | 0.8 | 0.9 | 99.0 | 99.4 |
| NaClO | ESPA2 | 7 | 2.0 | 4.1 | 95.4 | 88.5 |

When the mixture of the slime-suppressing auxiliary agent for a reverse osmosis membrane (potassium iodide aqueous solution) and sodium hypochlorite from the example was used, almost no degradation of the reverse osmosis membrane occurred.

### Example 6, Reference Examples 5 to 7

### Effect of Amount Added of Iodide Ions on Residual Free Chlorine Concentration

### Test Procedure

Using Sagamihara well water that had been subjected to a dechlorination treatment, a sodium hypochlorite aqueous solution was prepared with a concentration of 5 mg/L as Cl₂, and mixed solutions were then prepared by adding sufficient potassium iodide to provide 0, 0.5, 1.0 or 2.0 mol of iodide ions per 1 mol of free chlorine in the sodium hypochlorite solution. Subsequently, the free chlorine concentration remaining as hypochlorite in each mixed solution was measured.

Measurement of the free chlorine concentration remaining as hypochlorite was measured with reference to the “indophenol blue absorptiometry method (JIS K 102)”, by producing chloramine by adding a prescribed amount of ammonia to the mixed solution, adding and mixing a sodium phenoxide solution, leaving the mixture to stand for 30 minutes, and then measuring the absorbance in the vicinity of 630 nm to quantify the amount of chloramine produced. The quantified chloramine concentration was calculated as the amount of free chlorine remaining as hypochlorite in the mixed solution. The results are shown in Table 10.

TABLE 10

| | | Amount added | Free chlorine |
|---|---|---|---|
| | | of iodide ions | concentration remaining |
| | | per 1 mol of free | as hypochlorite |
| | pH | chlorine [mol] | [mg/L as Cl₂] |
| Example 6 | 7 | 2.0 | 0.00 |
| Reference Example 5 | 7 | 0 | 5.00 |
| Reference Example 6 | 7 | 0.5 | 2.40 |
| Reference Example 7 | 7 | 1.0 | 0.02 |

When 2 mol or more of iodide ions was added per 1 mol of free chlorine, no free chlorine was detected (less than the detection limit). In contrast, when the amount added of the iodide ions was 1.0 mol per 1 mol of free chlorine, a very small amount of free chlorine was detected. Because free chlorine derived from hypochlorite degrades the reverse osmosis membrane, it is preferable that free chlorine is not detected in the water to be treated by the reverse osmosis membrane. Accordingly, the amount added of the iodide ions is preferably 2.0 mol or greater.

### Examples 7 to 9, Reference Examples 8 to 13

### Effect of Amount Added of Iodide Ions on Oxidation-Reduction Potential (ORP)

### Test Procedure

A sodium hypochlorite aqueous solution was added to ultrapure water prepared with a prescribed pH value in sufficient amount to provide 1 mg/L as Cl₂, potassium iodide was then added to the solution and stirred for 3 minutes, and the oxidation-reduction potential (ORP) was then measured. The potassium iodide was added in sufficient amount to provide 0, 1.0 or 2.0 mol of iodide ions per 1 mol of free chlorine in the sodium hypochlorite solution. The oxidation-reduction potential (ORP) was measured using an ORP meter (RM-2oP) manufactured by DKK-TOA Corporation. The results are shown in Table 11.

TABLE 11

| | | Amount added of iodide | |
|---|---|---|---|
| | | ions per 1 mol of free | ORP |
| | pH | chlorine [mol] | [mV] |
| Example 7 | 4 | 2 | 679 |
| Reference Example 8 | 4 | 0 | 837 |
| Reference Example 9 | 4 | 1 | 786 |
| Example 8 | 7 | 2 | 515 |
| Reference Example 10 | 7 | 0 | 638 |
| Reference Example 11 | 7 | 1 | 532 |
| Example 9 | 10 | 2 | 455 |
| Reference Example 12 | 10 | 0 | 359 |
| Reference Example 13 | 10 | 1 | 477 |

The greater the amount added of the iodide ions, the more the oxidation-reduction potential (ORP) decreased. Particularly at pH 4, when the amount added of the iodide ions was 2 mol or more per 1 mol of free chlorine, the oxidation-reduction potential (ORP) decreased significantly, and fell beneath 700 mV which represents the oxidation-reduction potential (ORP) level at which any effect on the reverse osmosis membrane can be effectively ignored.

As shown in the examples, a slime-suppressing auxiliary agent for a reverse osmosis membrane which contained an iodide and provided good suppression of free iodine release was able to be obtained. Further, by using the slime-suppressing auxiliary agent for a reverse osmosis membrane described in the examples in the reverse osmosis membrane treatment of a water to be treated containing at least one of a chlorine-based oxidizing agent and a bromine-based oxidizing agent, degradation of the reverse osmosis membrane was able to be suppressed and slime formation was also able to be suppressed.

### REFERENCE SIGNS LIST

1: Water treatment device
10: Water to be treated tank
12: Membrane filtration device
14: Reverse osmosis membrane device
16: Pump
18, 20: Water to be treated line
22: Membrane filtration treated water line
24: Permeate line
26: Concentrate line
28: Slime-suppressing auxiliary agent addition line
30: Reducing agent addition line

1. A method for producing a slime-suppressing auxiliary agent for a reverse osmosis membrane, the method comprising adding an iodide and an alkali agent to a water having a free chlorine concentration of 0.2 mg/L or less.

2. A method for producing a slime-suppressing auxiliary agent for a reverse osmosis membrane, the method comprising:
removing free chlorine from a water having a free chlorine concentration exceeding 0.2 mg/L to reduce the free chlorine concentration to 0.2 mg/L or less, and
adding an iodide and an alkali agent to the water from which free chlorine has been removed.

3. A slime-suppressing auxiliary agent for a reverse osmosis membrane, the slime-suppressing auxiliary agent comprising:
an iodide, an alkali agent and water, and
having a free iodine concentration of 0.1 mg/L or less.

4. The slime-suppressing auxiliary agent for the reverse osmosis membrane according to claim 3, wherein
an iodide ion concentration is at least 3.8% by mass but less than 20% by mass.

5. The slime-suppressing auxiliary agent for the reverse osmosis membrane according to claim 3,
having a pH of 8 or higher.

6. A water treatment method comprising:
treating a water to be treated containing at least one of a chlorine-based oxidizing agent and a bromine-based oxidizing agent using a reverse osmosis membrane to obtain a concentrate and a permeate, wherein
the slime-suppressing auxiliary agent for the reverse osmosis membrane according to claim 3 is introduced into the water to be treated such that an amount of iodide ions is at least 2 mol per 1 mol of free chlorine and free bromine in the water to be treated.

7. A water treatment method comprising:
subjecting a water to be treated containing at least one of a chlorine-based oxidizing agent and a bromine-based oxidizing agent to a membrane filtration treatment using a separation membrane, and
treating a membrane filtration treated water obtained during the membrane filtration treatment using a reverse osmosis membrane to obtain a concentrate and a permeate, wherein
the slime-suppressing auxiliary agent for the reverse osmosis membrane according to claim 3 is introduced into the water to be treated during the membrane filtration treatment such that an amount of iodide ions is at least 2 mol per 1 mol of free chlorine and free bromine in the water to be treated.
